(19) United States
(12) Patent Application Publication
(10) Pub. No.: US 2005/0060118 A1
(43) Pub. Date: Mar. 17, 2005

(54) Terminal and an associated system, method and computer program product for obtaining the terminal location based upon connections of the terminal

(75) Inventors: Dana Pavel, Cambridge, MA (US); Ora Lassila, Hollis, NH (US); Dirk Trossen, Cambridge, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/660,004

(22) Filed: Sep. 11, 2003

(51) Int. Cl. G01C 9/00

(52) U.S. Cl. 702/150

(57) ABSTRACT

A system, method and computer program product are provided for obtaining a terminal location based upon connections of the terminal. The terminal includes a controller, and may additionally include a display. The controller is capable of establishing, and thereafter terminating, at least one defined connection, such as at least one defined communication and/or logical connection. The controller is also capable of monitoring the terminal for establishment of a defined connection, and for subsequent termination of the defined connection. Upon establishment and/or termination of the defined connection, then, the controller is capable of being triggered to obtain a location of the terminal. In turn, the display can be capable of presenting the location of the terminal.

### FIELD OF THE INVENTION

The present invention relates generally to systems and methods for obtaining terminal location information and, more particularly, relates to systems and methods for obtaining the location of a terminal in response to termination of communication and/or logical connections.

### BACKGROUND OF THE INVENTION

In many wireless communication networks and other mobile networks, terminals are capable of establishing communication connections with various entities, networks, devices or the like. For example, in many cellular communication networks, terminals are capable of establishing communication connections with the cellular communication network, such as to communicate with other terminals in the network. Also, for example, terminals may be capable of establishing communication connections with other devices, such as in accordance with techniques including, for example, infrared, radio frequency, Bluetooth technologies or the like.

Whereas it is often desirable for terminals to establish communication connections, it is also desirable to obtain information regarding the respective connections. For example, it is often desirable to provide an indication, such as a warning, when various connections are broken, particularly when the respective connections are broken in error. In this regard, in various instances terminal users are notified when the respective terminals establish a communication connection with various devices and/or networks. Similarly, terminal users may additionally or alternatively be notified when the communication connection between the terminals and the various devices and/or networks is terminated, interrupted or otherwise broken.

As will be appreciated, more and more, society is moving into a world of information. As such, although conventional terminals are capable of obtaining various pieces of information regarding communication and/or logical connections between the terminals and other devices, networks, entities or the like, it is always desirable to obtain further information regarding such connections.

### SUMMARY OF THE INVENTION

In light of the foregoing background, embodiments of the present invention provide a terminal and an associated system, method and computer program product that, in contrast to conventional systems and methods, are capable of obtaining a terminal location based upon connections of the terminal. The system, method and computer program product of embodiments of the present invention are capable of obtaining, and can be capable of storing, the location of the terminal upon termination of defined communication and/or logical connections of the terminal. In this regard, whereas conventional systems and methods may be capable of providing an indication of when a connection is established and/or terminated, embodiments of the present invention are further capable of obtaining, and thereafter providing, the location of the terminal when a connection is terminated. The location of the terminal can then be presented and utilized for any of a number of different purposes, such as to locate the entity connected to the terminal.

According to one aspect of the present invention, a terminal is provided. The terminal includes a controller, and may additionally include a display. The controller is capable of establishing, and thereafter terminating, at least one defined connection, such as at least one defined communication and/or logical connection. The controller is also capable of monitoring the terminal for establishment of a defined connection, and for subsequent termination of the defined connection. Advantageously, and in accordance with embodiments of the present invention, upon termination of the defined connection, the controller is capable of being triggered to obtain a location of the terminal.

When the connection comprises a communication connection, the controller can be capable of establishing, and thereafter terminating, at least one defined communication connection between the terminal and a predefined entity. When the connection comprises a logical connection, the logical connection can include a context, such as a context of the terminal and/or user of the terminal, specifying termination of the respective logical connection. As such, the controller can be capable of monitoring the terminal for the context specifying termination of the respective logical connection to thereby monitor for termination of the defined connection. More particularly, the controller can determine the context specifying termination of the respective logical connection based upon information indicative of the context. In such instances, the controller can be capable of monitoring the terminal for termination of the defined connection by monitoring for the information indicative of the context.

The display of the terminal may be capable of presenting the location of the terminal after the controller obtains the location. However, because the location of the terminal may not be defined in a manner recognizable by the terminal user, the controller can be capable of receiving the location of the terminal that has been transformed to thereby define the terminal in a predetermined manner. The display can then be capable of presenting the location of the terminal in the predetermined manner.

According to other aspects of the present invention, a system, method and computer program product are provided for obtaining a terminal location. Embodiments of the present invention therefore provide a terminal and an associated system, method and computer program product for obtaining a terminal location in response to termination of defined communication and/or logical connections. In contrast to conventional systems and methods, embodiments of the present invention are capable of obtaining, and can be capable of presenting, the location of the terminal. Also, in addition to communication connections, embodiments of the present invention are capable of monitoring logical connections defined based upon contexts. Then, upon termination of such logical connections, the location of the terminal can be obtained. Therefore, the systems and methods of embodiments of the present invention provide additional advantages over conventional systems and methods of monitoring connections.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a wireless communications network and a data network to which a terminal is bi-directionally coupled through wireless RF links;

FIG. 2 is a schematic block diagram of a terminal comprising a mobile station according to one embodiment of the present invention; and

FIG. 3 is a flow chart illustrating various steps in a method of obtaining a terminal location based upon connections with the terminal, according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

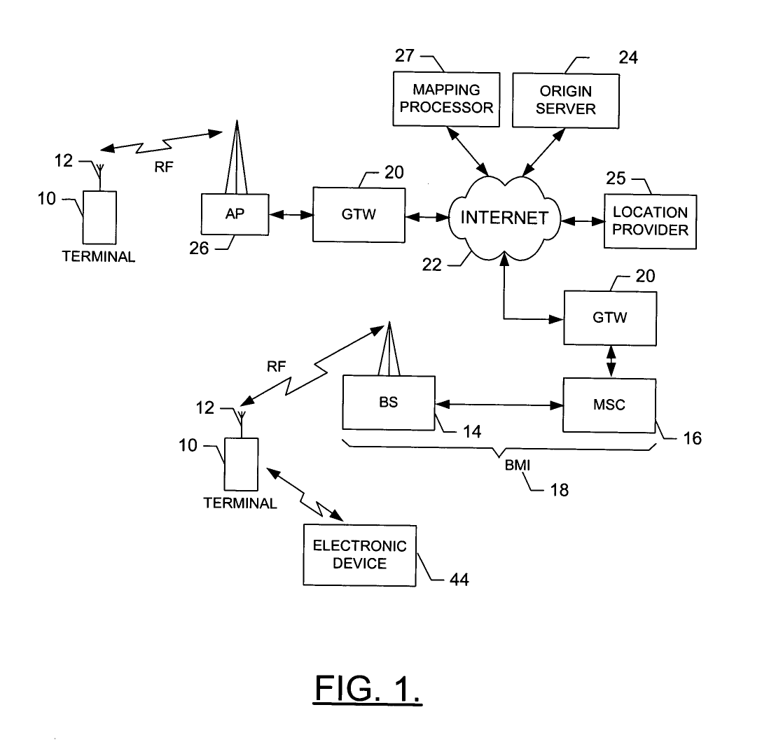

Referring to FIG. 1, an illustration of one type of terminal and system that would benefit from the present invention is provided. The system, terminal and method of the present invention will be primarily described in conjunction with mobile communications applications. It should be understood, however, that the system and method of the present invention can be utilized in conjunction with a variety of other applications, both in the mobile communications industries and outside of the mobile communications industries. For example, the system and method of the present invention can be utilized in conjunction with wireline and/or wireless network (e.g., Internet) applications including communicating in accordance with the Hypertext Transfer Protocol (HTTP).

As shown, a terminal 10 may include an antenna 12 for transmitting signals to and for receiving signals from a base site or base station (BS) 14. The base station is a part of a wireless communications network that includes elements required to operate the network, such as a mobile switching center (MSC) 16. As well known to those skilled in the art, the wireless communications network may also be referred to as a Base Station/MSC/Interworking function (BMI) 18. In operation, the MSC is capable of routing calls and messages to and from the terminal when the terminal is making and receiving calls. The MSC also provides a connection to landline trunks when the terminal is involved in a call. Further, the MSC can, but need not, be coupled to a server GTW 20 (Gateway).

The MSC 16 can be coupled to a data network, such as a local area network (LAN), a metropolitan area network (MAN), and/or a wide area network (WAN). The MSC can be coupled to the data network directly, or if the system includes a GTW 20 (as shown), the MSC can be coupled to the network via the GTW. In one typical embodiment, for example, the MSC is coupled to the GTW, and the GTW is coupled to a WAN, such as the Internet 22. In turn, devices such as processing elements (e.g., personal computers, server computers or the like) can be coupled to the terminal 10 via the Internet. For example, the processing elements can include one or more processing elements associated with one or more origin servers 24, location providers 25 and/or mapping processors 27, one of each being illustrated in FIG. 1. In addition to the origin servers, location providers and/or mapping processors, the network may be coupled to one or more wireless access points (APs) 26. In turn, the APs may be wirelessly coupled to one or more terminals 10. As will be appreciated, by directly or indirectly connecting the terminals and the other devices (e.g., origin servers, location providers, mapping processors, etc.) to the Internet, the terminals can communicate with the other devices and with one another, such as according to the Hypertext Transfer Protocol (HTTP), to thereby carry out various functions of the terminal.

As indicated above and explained below, to provide the location of the terminal 10, the system may include one or more location providers 25. But because the location of the terminal may be defined in a manner not recognizable by the terminal user, the terminal and/or a mapping processor 27 may be capable of transforming the location of the terminal to define the terminal location in a predetermined manner recognizable to the terminal user, such as an address or other logical location, and/or a geographical representation of the terminal location. In this regard, the mapping processor can be capable of receiving, and thereafter transforming one or more terminal locations defined in one or more different manners. As shown and described, the mapping processor and the location provider are distributed from one another, such as across the Internet 22. It should be understood, however, that the mapping processor and location provider can alternatively be logically co-located, without departing from the spirit and scope of the present invention.

The location provider 25 can be arranged to receive a request for location information, such as from the terminal 10 itself. In such instances, the request for location information can include the identity of the terminal such as an international mobile subscriber identifier (IMSI), or a temporary identifier such as a temporary international mobile subscriber identifier (TIMSI). The location provider may respond to a location request with location information for the terminal. The location provider may therefore provide, on request, the current or most recent location (if available) of the target terminal or, if the location determination fails, an error indication and optionally the reason for the failure. For more information on one type of location provider, often referred to as a location server, see European telecommunications Standards Institute (ETSI) technical specification entitled: Location Services (3GPP TS23.171 and GSM 03.71), the contents of which are hereby incorporated by reference in its entirety.

The location of the terminal 10, such as from the location provider 25 or the terminal itself (described below), can be defined in any of a number of different manners. For example, the location can be defined as a logical location (e.g., Boston, Boston Common, Central Park, etc.). Also, for example, the location can be defined as a set of geographic (X, Y, Z) coordinates, where the geographic (X, Y, Z) coordinates may, but need not, include a Z coordinate. In addition, for example, the location can be defined as a set of geographic latitude and longitude coordinates. Further, the location can be defined by a cell ID, where the location can be defined as a cell identifier that identifies a geographic area through the coverage area of the cell (e.g., GSM cell) associated with the cell ID.

As yet another example, the location may be defined by an RF identifier (RFID) (e.g., 32-bit identifier). In such instances, the location can be defined by an RFID, and may also be defined to include a name or other identifier of a provider associated with the RFID. In this regard, a location can be “tagged” by the terminal 10, as such by an RFID tag at a respective location, and thereafter recalled based upon the RFID provided by the RFID tag and the associated provider. For example, consider a parking lot of a large shopping center, where the parking lot is divided into geographic quadrants that each include an associated RFID tag. In such instances, the RFID of each tag can identify a specific geographic quadrant of the parking lot, and a provider (if provided) can comprise the shopping center.

The location provider 25 can be implemented in the core network and be arranged to determine the location of the terminal 10 in any of a number of different manners. For example, the location provider can be capable of determining the location of the terminal based upon location information from the wireless communication network via the MSC 16 and/or a serving general packet radio service support node (SGSN) (not shown). Additionally or alternatively, for example, the location provider can determine the location of the terminal in accordance with any of a number of other techniques including, for example, triangulation, Global Positioning System (GPS), Assisted GPS (A-GPS), Time of Arrival (TOA), Observed Time Difference of Arrival (OTDOA) or the like, as such are well known to those skilled in the art.

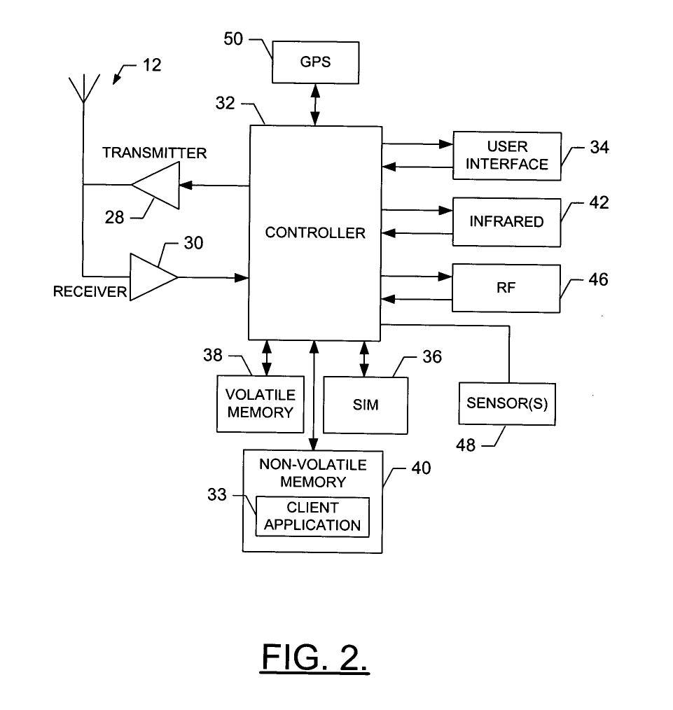

Although shown and described herein as being coupled to the Internet 22, it should be appreciated that the location provider 25 may be logically located anywhere in the data network and/or wireless communications network. Also, the location provider may be distributed between several elements of the network, or may be implemented in a single element. In addition, the location provider may also be an external node to the wireless communications network. Further, for example, the terminal 10 or user equipment may include the location provider (e.g., GPS sensor 50—see FIG. 2), and thus provide the location provider functionality. In such instances, the terminal is capable of generating location information thereof.

Reference is now drawn to FIG. 2, which illustrates a block diagram of one type of terminal 10, a mobile station, that would benefit from the present invention. It should be understood, however, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of terminals, such as pagers, personal computers, laptop computers, personal digital assistants (PDAs) and other types of voice and text communications systems, can readily employ the present invention. In this regard, the terminal any of a number of different terminals that include a processing element or controller, and that are capable of communicating over the Internet 22 either directly or indirectly, such as via the wireless APs 26 and/or the BMI 18.

As shown, the mobile station includes a transmitter 28, a receiver 30, and a controller 32 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 32 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. Further, the controller may include the functionally to operate one or more software programs, which may be stored in memory (described below). For example, the controller may be capable of operating a connectivity program, such as a conventional Web browser, that allows the mobile station to transmit and receive Web content, such as according to HTTP, for example. Also, for example, the controller may be capable of operating a client application 33 capable of obtaining the location of the terminal at establishment and/or termination of one or more connections between a terminal and one or more entities, as described in more detail below.

The mobile station also comprises a user interface 34 that may include a conventional earphone or speaker, a ringer, a microphone, a display, and a user input interface, all of which are coupled to the controller 32. The user input interface, which allows the mobile station to receive data, can comprise any of a number of devices allowing the mobile station to receive data, such as a keypad, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 36, a removable user identity module (R-UIM) or the like, which typically stores information elements related to a mobile subscriber. In addition to the SIM, the mobile station can include other memory. In this regard, the mobile station can include volatile memory 38, such as volatile Random Access Memory (RAM) including a cache area for the temporary storage of data. The mobile station can also include other non-volatile memory 40, which can be embedded and/or may be removable. The memories can store any of a number of pieces of information, and data, used by the mobile station to implement the functions of the mobile station. For example, the memories can include an identifier, such as an international mobile equipment identification (IMEI) code, capable of uniquely identifying the mobile station, such as to the MSC 16.

Also, for example, the non-volatile memory 40 can store software, such as client application 33, the operation of which is described in more detail below. As shown and described herein a client application, such as client application 33, comprises software executed by a terminal 10, such as by the controller 32 of the mobile station. It should be understood, however, that the functions of the client application can equally be implemented in hardware, firmware or the like, without departing from the spirit and scope of the present invention. It should also be understood that although the client application is shown and described as being co-located with the terminal, the client application can equally be distributed from the terminal.

The mobile station can further include an infrared transceiver 42 and/or other wireline and/or wireless local data transfer devices so that data can be shared with and/or obtained from other electronic devices 44 (one of which is shown in FIG. 1) such as other mobile stations, car guidance systems, personal computers, printers, printed materials including barcodes and the like. The sharing of data, as well as the remote sharing of data, can also be provided according to a number of different techniques. For example, the mobile station may include a radio frequency transceiver 46 capable of sharing data with other radio frequency transceivers, and/or with a Radio Frequency Identification (RFID) transponder tag, as such is known to those skilled in the art. Additionally, or alternatively, for example, the mobile station may share data using Bluetooth brand wireless technology developed by the Bluetooth Special Interest Group. Further, although not shown, the mobile station may share data using universal serial bus (USB) technology.

The mobile station may also have one or more sensors 48 for sensing the ambient conditions of the mobile user and, more particularly, the mobile station operated by, or otherwise under the control of, the mobile user. In this regard, the mobile station may include sensors such as, for example, a positioning sensor, a touch sensor, an audio sensor, a compass sensor, an ambient light sensor, an ambient temperature sensor and/or a three-axis acceleration sensor. The audio sensor can comprise a microphone as part of the user interface 34, for example, which can detect speech or environmental sounds. The positioning sensor can comprise, for example, a GPS sensor 50. Additionally, or alternatively, the positioning sensor can comprise, for example, a radio beacon triangulation sensor that determines the location of the wireless device by means of a network of radio beacons, base stations, or access points, as is described for example, in Nokia European patent EP 0 767 594 A3, entitled: Mobile Station Positioning System, published on May 12, 1999, the contents of which are hereby incorporated by reference in its entirety.

As will be appreciated, the sensors 48 can also be located in accessory-like mobile station covers and/or in a wireless accessory such as a Bluetooth-enabled device. The sensors may further be located in the environment such as in the user's rooms or vehicles. Also, information capable of being measured by the mobile station, such as the time duration of use of the mobile station, can be received as sensor data by the mobile station. For more information on such sensors, see U.S. patent application Ser. No. 09/854,628, entitled: Context Sensitive Web Services, filed May 15, 2001, which published on Nov. 21, 2002 as U.S. Patent Application Publication No. 2002/0173295, the contents of which is hereby incorporated by reference in its entirety.

As indicated in the background section, although conventional terminals are capable of obtaining various pieces of information regarding communication connections between the terminals and other devices, networks, entities or the like, it is always desirable to obtain further information regarding such connections. As such, and in accordance with embodiments of the present invention, the terminal 10 is capable of establishing a connection with an entity, such as an electronic or other device 44, network or the like. In response to establishment and/or termination of the connection, then, the location of the terminal is capable of being determined. In this regard, a terminal user may be presented with the location of the terminal at an instance of establishment and/or termination of the terminal with the entity. The terminal user can then utilize such information for any of a number of different purposes, such as to determine the location of an electronic device 44 or other entity previously connected to the terminal, where the location is determined at the time the connection between the terminal and device or entity broke.

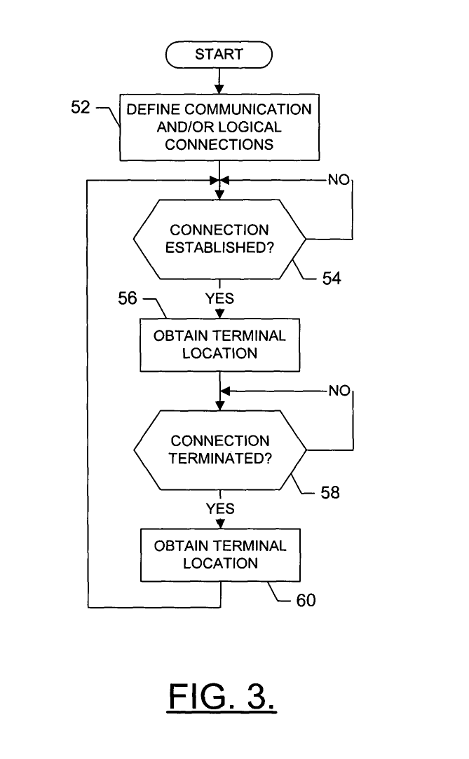

Reference is now made to FIG. 3, which illustrates various steps in a method for obtaining a terminal location in accordance with one embodiment of the present invention. Generally, the illustrated method begins by defining one or more communication and/or logical connections, as shown in block 52, where an associated entity can also be defined for one or more connections. Any of a number of different wireline and/or wireless connections and associated entities can be defined in any of a number of different manners, such as by utilizing a user interface (e.g., user interface 34) of the terminal 10. For example, a voice and/or data communication connection can be defined between the terminal and the BMI 18 or AP 26. Also, for example, a data communication connection (e.g., infrared, radio frequency, Bluetooth, USB, etc.) can be defined between the terminal and an electronic device 44, where the electronic device can, but need not, be specified.

In addition to, or in lieu of, one or more communication connections, one or more logical connections can be defined for the terminal 10. Like before, the logical connections can, but need not, also specify one or more entities associated with the respective logical connections. Because establishment and/or termination of a logical connection may not be identified based upon data transfer, as may communication connections, each logical connection is typically defined to also include one or more contexts, such as contexts of the terminal and/or the user of the terminal, that specify when the logical connection is established, and may additionally or alternatively specify when the logical connection is terminated or otherwise broken.

As will be appreciated, each context can be defined based upon information indicative of establishment and/or termination of a connection, where the information may be determined and/or received by the terminal. For example, consider defining a logical connection between the terminal and a vehicle (i.e., entity). In such an instance, establishment of the connection can be identified by the context of the terminal or user being located within the vehicle, while termination of the connection can be identified by the context of the terminal or user being located outside the vehicle. The contexts of the location of the terminal or user with respect to the vehicle, then, can be based upon information capable of identifying the terminal or user as being located inside, then outside, the vehicle.

The information indicative of the defined context can comprise any one or more of a number of different pieces of information. For example, the information can comprise an identifier (e.g., RFID) of a vehicle, where the identifier is capable of being continuously received by the terminal 10 (e.g., via radio frequency transceiver 46) while the terminal is inside the vehicle. Alternatively, for example, a three-axis acceleration sensor can measure movement of the terminal. Thereafter, the movement can be processed into information that may include the current absolute value of acceleration, the value integrated over several seconds, and/or a rough estimate whether the terminal or user of the terminal is sitting in the vehicle. As will be appreciated, the information indicative of the context can comprise one or more pieces of information fused or aggregated from several sources.

Irrespective of the exact manner in which the communication and/or logical connections are defined, after defining the connections, the terminal 10, or more particularly the client application 33, can continuously monitor for establishment of a defined connection, as shown in block 54. More particularly, for example, the client application can monitor for establishment of one or more communication connections by monitoring the terminal for data transmitted to, or received from, the entity associated with the defined communication connections. Additionally, or alternatively, the client application can monitor for establishment of one or more logical connections by monitoring for the context establishing the respective logical connections, such as by monitoring for information indicative of the respective context.

After establishment of a defined communication and/or logical connection, if so desired, the client application 33 can obtain the location of the terminal 10, as shown in block 56. The client application can obtain the location of the terminal without interaction from the terminal user. In one embodiment, however, the client application receives consent from the terminal user, such as via the user interface 34, before obtaining the location of the terminal. The client application can obtain the location of the terminal in any of a number of different manners, such as from the terminal itself or from the location provider 28, which may also receive consent from the terminal user before determining the location of the terminal, if so desired. For example, the terminal can be responsible for determining its current location, and passing the current location to the client application. In such instances, the terminal can determine its current location in any of a number of different manners. For example, the terminal can be capable of determining its current location based upon information obtained by the access technology of the terminal, such as the current cell ID. Additionally, or alternatively, the terminal can determine its current location from sources local to, or distributed from, the terminal. For example, the terminal can determine its current location from a GPS sensor, such as GPS sensor 50 (see FIG. 2).

In addition to, or in lieu of, the terminal 10 determining its current location and passing its current location to the client application 33, the location provider 28 can be responsible for determining the current location. In this regard, the location provider can determine the location of the terminal, such as in accordance with any of the number of manners described above. After determining the location of the terminal, the location provider can then send the location to the terminal, or more particularly the client application, such as accordance with any of a number of different known techniques.

Irrespective of how the client application 33 obtains the location of the terminal 10, after obtaining the location of the terminal, the client application can, if so desired, store the location of the terminal. The client application can store the location of the terminal without interaction from the terminal user. In one embodiment, however, the client application receives consent from the terminal user, such as via the user interface 34, before storing the location of the terminal. The client application can store the location of the terminal in any of a number of different manners, such as by storing the location within non-volatile memory 40. As will be appreciated, the client application can merely store the location of the terminal. According to advantageous embodiments of the present invention, however, the client application stores the location of the terminal along with a number of different pieces of information related to the terminal, entity associated with the connection and/or the established connection. For example, in addition to the location of the terminal, the client application can store the type of connection, the time the connection was established, and/or the entity associated with the connection (e.g., entity communicating with the terminal or otherwise associated with the defined connection). Also, for example, the client application can store the context when the connection was established, and/or readings from various sensors (e.g., sensors 48) providing information indicative of the context.

After the connection has been established, the terminal 10, or more particularly the client application 33, can continuously monitor for termination of the established connection, as shown in block 58, such as in the same manner as monitoring for establishment of the connection. In this regard, the client application can, for example, monitor for termination of one or more communication connections by monitoring the terminal for closing of a communication session, or by monitoring the terminal for the absence of data transmitted to or from the terminal for a predefined timeout period. Additionally, or alternatively, the terminal can monitor for termination of one or more logical connections by monitoring for the information indicative of the context terminating the respective logical connections.

After termination of the established communication and/or logical connection, the client application 33 can again obtain the location of the terminal 10, as shown in block 60. As before, the client application can obtain the location of the terminal in any of a number of different manners, such as from the terminal itself or from the location provider 28. In addition, after obtaining the location of the terminal, the client application can again, if so desired, store the location of the terminal, such as within non-volatile memory 40. Further, the client application can store the location of the terminal along with a number of different pieces of information related to the terminal, entity associated with the connection and/or the established connection (e.g., the type of connection, the time the connection was terminated, the entity associated with the connection, the context at connection termination, and/or readings from various sensors).

After obtaining the location of the terminal 10 at termination of the connection, or more generally at any point after defining the communication and/or logical connections, the client application 33 can continue to monitor the terminal for establishment, and thereafter termination, of defined communication and/or logical connections. Also, at any time after obtaining the location of the terminal, the location of the terminal, as well as the other pieces of information stored with the location, may be presented to the terminal user. The location and other information can be presented in any of a number of different manners, such as via a display of the user interface 34 of the terminal.

As will be appreciated, in various instances it may be desirable to reformat the location of the terminal 10 to thereby define the location in a predetermined manner recognizable by the terminal user. For example, in various instances, the location of the terminal may be obtained and thereafter stored in a geographical (X, Y, Z) format. In such instances, the terminal user may not recognize a location by its geographical (X, Y, Z) coordinates. Thus, the client application 33 may be capable of reformatting the location of the terminal after obtaining the location and before presenting the location. Alternatively, the client application may be capable of communicating with a mapping processor 27, where the mapping processor is capable of reformatting the location. The location can be reformatted by the terminal and/or mapping processor in any of a number of different manners to thereby define the location in a manner recognizable to the terminal user. For example, the location may be reformatted to define the location of the terminal as an address (e.g., “123 Location Ave., Boston, Mass., 12345), a logical location (e.g., “Boston,” “Boston Common,” “Central Park,” etc.) or the like, and/or a graphical representation of the location of the terminal.

As an exemplar application of embodiments of the present invention, consider a user having a terminal 10, and driving a vehicle to a large shopping center. Once at the shopping center, the terminal user parks the vehicle in the parking lot, and enters the shopping center, all while carrying the terminal. While the user is within the vehicle, a logical connection is established between the terminal and the vehicle, the connection having been previously defined by the terminal user. For example, the logical connection can be established based upon the terminal (e.g., via radio frequency transceiver 46) receiving an identifier (e.g., RFID) of the vehicle upon entering the vehicle, and thereafter continuously receiving the identifier while inside the vehicle. As will soon be appreciated, in such a case, it may not be desirable to obtain and store the location of the terminal upon establishment of the connection, so the client application 33 may not obtain and store the location of the terminal when the terminal establishes the logical connection with the vehicle.

When the user, and thus the terminal 10, exits the vehicle in the parking lot of the shopping center, the logical connection between the terminal and the vehicle is broken, such as by the terminal ceasing to receive an identifier (e.g., RFID) of the vehicle. As such, the client application 33 obtains and stores the location of the terminal. And as will be appreciated, because the connection terminated when the terminal exited the vehicle, the location of the terminal stored by the client application approximately equals the location of the vehicle. In this regard, presume that when the terminal user leaves the shopping center, the user forgets the location of the vehicle in the parking lot. Because the client application stored the location of the terminal when the user exited the vehicle, and because the obtained location of the terminal approximately equaled the location of the vehicle, the terminal can present the location of the vehicle to the user such that the user can locate the vehicle.

As will be appreciated, in cases such as that above, it may be desirable to locate identifiers, such as RFID tags, throughout the parking lot, where each RFID tag is capable of providing an RFID that identifies a specific geographic quadrant of the parking lot. As such, when the connection between the terminal 10 and the vehicle is broken, the client application 33 can obtain the location of the terminal, and thus the vehicle, from the RFID, such as via the radio frequency transceiver 46.

In another exemplar application, consider a defined Bluetooth communication connection between a terminal 10 and a PDA. At some point, the terminal user establishes a communication connection between the terminal and the PDA, such as to synchronize calendar applications operating on the terminal and PDA. In such an application, as in the case of the vehicle, it may not be desirable to obtain and store the location of the terminal upon establishment of the connection, so the client application 33 may not obtain and store the location of the terminal when the terminal establishes the communication connection with the PDA.

After synchronizing the calendar applications of the terminal 10 and the PDA, the terminal user, with the terminal, walks away from the PDA. The communication connection between the terminal and the PDA is thus broken. Similar to before, when the connection between the terminal and the PDA is terminated, the client application 33 obtains and stores the location of the terminal. Because the connection terminated when the terminal walked away from the PDA, the location of the terminal obtained by the client application approximately equals the location of the PDA when the connection is broken. As such, the terminal can present the location of the PDA to the terminal user, such as in instances in which the user forgets the location of the PDA subsequent to synchronizing the terminal and the PDA.

As will be appreciated by those skilled in the art, in various instances, it may be desirable to configure the terminal 10 to refrain from obtaining and/or storing the location of the terminal, such as during establishment of a connection, and/or when the obtained location of the terminal has a predefined value or is within a predefined range of values. Continuing the exemplar case of the vehicle above, for example, the terminal may be configured to refrain from storing the location of the terminal, and thus the vehicle, when the vehicle is located at, or within a specified distance from, the terminal user's residence when the logical connection between the terminal and the vehicle is broken.

As shown and described herein, the client application 33 is co-located with, and executed by, the terminal (e.g., by the controller 50). It should be understood, however, that the client application, or at least a portion of the client application, may equally be distributed from the terminal. For example, portions of the client application may be executed by any one or more of the other elements of wireless communications network (e.g., BMI 18), data network (e.g., origin server 24), and/or any one or more dedicated processors (not shown) coupled to the cellular and/or data network. In such instances, at least a portion of the functionality of the client application 33 can be performed independent of the terminal.

More particularly, processors executing portions of the client application 33 can be capable of monitoring establishment and/or termination of defined communication and/or logical connections, such as by receiving an indication of the same from the terminal 10, the entity associated with the connection and/or the information indicative of the context defining the same. Additionally, or alternatively, the processors executing portions of the client application can be capable of obtaining and/or storing the location of the terminal. Also, the processors can additionally or alternatively be capable of presenting the stored locations of the terminal. By providing at least a portion of the functionality of the client application independent of the terminal, the terminal can be freed from at least a portion of the processing resources required to execute the client application. Also, in instances in which the location of the terminal is stored by a processor distributed from the terminal, the location of the terminal can be recalled without the terminal, such as in instances in which the terminal user has misplaced the terminal.

According to one aspect of the present invention, the system and/or terminal 10 of embodiments of the present invention generally operates under control of a computer program product, such as the client application 33. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 3 is a flowchart of a method, system and program product according to the invention. It will be understood that each block or step of the flowchart, and combinations of blocks in the flowchart, can be implemented by computer program instructions. These computer program instructions may be loaded onto a computer or other programmable apparatus, such as the terminal 10, to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. For example, as described above, the location of the terminal is obtained upon establishment and/or termination of a connection. It should be understood, however, that the location of the terminal can equally be obtained one or more times after establishing the respective connection and before termination of the respective termination. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of obtaining a terminal location comprising:
defining at least one connection of the terminal;
monitoring the terminal for establishment of a defined connection;
monitoring the terminal for termination of the defined connection after the defined connection is established such that termination of the defined connection triggers obtaining a location of the terminal.

2. A method according to claim 1, wherein defining at least one connection comprises defining at least one communication connection between the terminal and a predefined entity.

3. A method according to claim 1, wherein defining at least one connection comprises defining at least one logical connection each of which includes a context specifying termination of the respective logical connection, and wherein monitoring the terminal for termination of a defined connection comprises monitoring the terminal for the context specifying termination of the respective logical connection.

4. A method according to claim 3, wherein the context specifying termination of the respective logical connection can be determined based upon information indicative of the context, and wherein monitoring the terminal for termination of the defined connection comprises monitoring for the information indicative of the context.

5. A method according to claim 1 further comprising:
transforming the location of the terminal to thereby define the terminal in a predetermined manner, and thereafter presenting the location of the terminal in the predetermined manner.

6. A method according to claim 1, wherein monitoring the terminal for establishment of a defined connection comprises monitoring the terminal for establishment of a defined connection such that establishment of the defined connection triggers obtaining a location of the terminal.

7. A system comprising:
a terminal capable of establishing, and thereafter terminating, at least one defined connection, wherein the terminal is capable of being triggered to obtain a location of the terminal upon termination of a defined connection; and
a location provider capable of determining the location of the terminal upon termination of the defined connection, and thereafter providing the location to the terminal.

8. A system according to claim 7, wherein the terminal is capable of establishing, and thereafter terminating, at least one defined communication connection between the terminal and a predefined entity.

9. A system according to claim 7, wherein the terminal is capable of establishing, and thereafter terminating, at least one defined logical connection each of which includes a context specifying termination of the respective logical connection, and wherein the terminal is capable of monitoring the terminal for termination of the defined connection by monitoring the terminal for the context specifying termination of the respective logical connection.

10. A system according to claim 9, wherein the terminal can determine the context specifying termination of the respective logical connection based upon information indicative of the context, and wherein the terminal is capable of monitoring the terminal for termination of the defined connection by monitoring for the information indicative of the context.

11. A system according to claim 8 further comprising:
a mapping processor capable of communicating with the location provider to transform the location of the terminal to thereby define the terminal in a predetermined manner such that the location of the terminal can be presented in the predetermined manner.

12. A system according to claim 7, wherein the terminal is capable of being triggered to obtain a location of the terminal upon establishment of a defined connection.

13. A terminal comprising:
a controller capable of establishing, and thereafter terminating, at least one defined connection, wherein the controller is capable of monitoring the terminal for establishment of a defined connection, and for subsequent termination of the defined connection, and wherein the controller is capable of being triggered to obtain a location of the terminal upon termination of the defined connection.

14. A terminal according to claim 13, wherein the controller is capable of establishing, and thereafter terminating, at least one defined communication connection between the terminal and a predefined entity.

15. A terminal according to claim 13, wherein the controller is capable of establishing, and thereafter terminating, at least one defined logical connection each of which includes a context specifying termination of the respective logical connection, and wherein the controller is capable of monitoring the terminal for termination of the defined connection by monitoring the terminal for the context specifying termination of the respective logical connection.

16. A terminal according to claim 15, wherein the controller can determine the context specifying termination of the respective logical connection based upon information indicative of the context, and wherein the controller is capable of monitoring the terminal for termination of the defined connection by monitoring for the information indicative of the context.

17. A terminal according to claim 13, wherein the controller is capable of receiving the location of the terminal transformed to thereby define the terminal in a predetermined manner, and wherein the terminal further comprises:
a display capable of presenting the location of the terminal in the predetermined manner.

18. A terminal according to claim 13, wherein the controller is capable of being triggered to obtain a location of the terminal upon establishment of the defined connection.

19. A computer program product for obtaining a terminal location, the computer program product comprising a computer-readable storage medium having computer-readable program code portions stored therein, the computer-readable program code portions comprising:
a first executable portion for receiving at least one defined connection of the terminal;
a second executable portion for monitoring the terminal for establishment of a defined connection;
a third executable portion for monitoring the terminal for termination of the defined connection after the defined connection is established such that termination of the defined connection triggers obtaining a location of the terminal.

20. A computer program product according to claim 19, wherein the first executable portion is adapted to receive at least one defined communication connection between the terminal and a predefined entity.

21. A computer program product according to claim 19, wherein the first executable portion is adapted to receive at least one defined logical connection each of which includes a context specifying termination of the respective logical connection, and wherein the third executable portion is adapted to monitor the terminal for the context specifying termination of the respective logical connection.

22. A computer program product according to claim 21, wherein the context specifying termination of the respective logical connection can be determined based upon information indicative of the context, and wherein the third executable portion is adapted to monitor for the information indicative of the context.

23. A computer program product according to claim 19 further comprising:
a fourth executable portion for transforming the location of the terminal to thereby define the terminal in a predetermined manner such that the location of the terminal can thereafter be presented in the predetermined manner.

24. A computer program product according to claim 19, wherein the second executable portion is adapted to monitor the terminal for establishment of a defined connection such that establishment of the defined connection triggers obtaining a location of the terminal.
